(19) United States
(12) Patent Application Publication
(10) Pub. No.: US 2026/0073455 A1
(43) Pub. Date: Mar. 12, 2026

(54) AUTOMATED RISK ASSESSMENT FOR CONTINUATION EVENTS

(71) Applicant: Pankaj GUPTA, Edison, NJ (US)

(72) Inventor: Pankaj GUPTA, Edison, NJ (US)

(21) Appl. No.: 19/108,008

(22) PCT Filed: Oct. 6, 2023
(86) PCT No.: PCT/US23/76257

§ 371 Date: Feb. 28, 2025

Related U.S. Application Data
(60) Provisional application No. 63/378,753, filed on Oct. 7, 2022.

(51) Int. Cl. G06Q 40/08; G06Q 10/1053

(52) U.S. Cl. CPC G06Q 40/0822; G06Q 10/1053

(57) ABSTRACT

Concepts related to automatically assessing risk associated with continuation events are described. In one embodiment, a computing device includes a memory device to store computer-readable instructions thereon. The computing device further includes at least one processing device configured to execute a search of at least one digital platform having data associated with an employee of an organization via a computer network. The at least one processing device is further configured to identify data indicative of a potential continuation event associated with at least one of the organization or the employee. The at least one processing device is further configured to determine, using a machine learning model and based at least in part on the data, a risk score for the potential continuation event occurring within a time frame.

### CROSS REFERENCE TO RELATED APPLICATIONS

This application claims the benefit of and priority to U.S. Provisional Application Ser. No. 63/378,753, filed Oct. 7, 2022, titled “AUTOMATED RISK ASSESSMENT FOR CONTINUATION EVENTS,” the entire contents of which are hereby incorporated herein by reference.

### BACKGROUND

The occurrence of layoffs, downsizing, or outsourcing by an organization can be unexpected for employees of the organization who are affected by such events. Such occurrences may require some employees to determine whether and how to continue with certain contracts, products, or services that were effective during employment. For instance, the termination of an employee from an organization may prompt the employee to determine whether and how to continue or keep in place a health insurance policy that was effective during a period of employment with the organization.

One option that may be available for continuing the employee's health insurance coverage after termination is provided under the Consolidated Omnibus Budget Reconciliation Action of 1985 (COBRA). Under COBRA, employees and their families have the right to continue with the health insurance benefits that were provided by their former employer for a limited period of time under certain circumstances.

### SUMMARY

The present disclosure is directed to performing automated risk assessments to assess risk associated with continuation events. More specifically, described herein is a risk assessment framework that can be implemented to assess risk associated with continuation events. Continuation events are defined herein as an event triggering the change of an official status of an individual or employee. Example continuation events include, but are not limited to, at least one of a status change from employed to unemployed, from active to disabled, or another status change. These events could be due to, for instance, layoffs, downsizing, and outsourcing events of an organization, among other events. To assess such risk, the risk assessment framework can continuously or periodically search various data sources that have information associated with at least one of an organization or an employee thereof (e.g., a current or former employee). The information obtained from such sources may be indicative of or suggest the potential for one or more continuation events to occur in connection with at least one of the organization or the employee. The risk assessment framework can be embodied and implemented in some embodiments as a predictive modeling tool that can use the data obtained from such sources to automatically determine a risk of the one or more continuation events actually occurring within a certain time frame. The risk assessment framework can also use a risk score determined from such an assessment to perform one or more operations based on at least one of the risk score or an occurrence of the one or more continuation events.

Aspects and advantages of embodiments of the present disclosure will be set forth in part in the following description or can be learned from the description or through practice of the embodiments. Other aspects and advantages of embodiments of the present disclosure will become better understood with reference to the appended claims and the accompanying drawings, all of which are incorporated in and constitute a part of this specification. The drawings illustrate example embodiments of the present disclosure and, together with the description, serve to explain the related concepts of the present disclosure.

According to one example embodiment, a computing device includes a memory device to store computer-readable instructions thereon. The computing device further includes at least one processing device configured to execute a search of at least one digital platform having data associated with an employee of an organization via a computer network. The at least one processing device is further configured to identify data indicative of a potential continuation event associated with at least one of the organization or the employee. The at least one processing device is further configured to determine, using a machine learning model and based at least in part on the data, a risk score for the potential continuation event occurring within a time frame.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the concepts of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates an example networked environment for automated continuation event assessment in accordance with at least one embodiment of the present disclosure.

FIG. 2 illustrates a flowchart of an example method for automated continuation event risk assessment in accordance with at least one embodiment of the present disclosure.

FIG. 3 illustrates a block diagram of an example computing environment in accordance with at least one embodiment of the present disclosure.

FIG. 4 illustrates a block diagram of another example networked environment for automated continuation event assessment in accordance with at least one embodiment of the present disclosure.

FIG. 5 illustrates a flowchart of another example method for automated continuation event risk assessment in accordance with at least one embodiment of the present disclosure.

FIG. 6 illustrates a flowchart of another example method for automated continuation event risk assessment in accordance with at least one embodiment of the present disclosure.

### DETAILED DESCRIPTION

As noted above, the Consolidated Omnibus Budget Reconciliation Action of 1985 (COBRA) gives workers and their families who lose their health benefits the right to choose to continue group health benefits provided by their group health plan for limited periods of time under certain circumstances such as involuntary job loss. Before 2010, this was particularly important for those with preexisting conditions who would be unable to access health coverage outside of group health plans. Compared to health coverage provided by an employer as an employee benefit, COBRA can be considered relatively expensive. This is because the individual often must bear the full cost of the coverage, plus an administrative fee in many cases.

While the Patient Protection and Affordable Care Act of 2010 allows individuals to access health coverage through a marketplace regardless of preexisting conditions, there may be reasons why an individual would choose COBRA continuation coverage in lieu of marketplace coverage after an involuntary job loss. As an example, an individual may have met the deductible for the year under the group health plan of their former employer. In that case, it is often better to continue with the group health plan of their former employer as COBRA continuation coverage and to pay for the COBRA premiums than it is to start coverage under a new plan with a new deductible. As another example, coverage under the COBRA plan may be more favorable than that offered by a new employer or the marketplace in terms of in-network hospitals and physicians, covered conditions, prescription benefits, and so on. However, COBRA premiums may be relatively costly and unaffordable in some cases for many individuals who would otherwise benefit from continuation coverage. Such premiums may be particularly unaffordable given that the individual has left a job involuntarily and often unexpectedly.

A provider may wish to offer an insurance product for continuation events, such an election to continue with the healthcare coverage under a group health plan of a former employer as COBRA continuation coverage. The insurance product could pay for the costs of the full insurance premium, or the difference between COBRA premium and active premium, for continuation health insurance coverage under COBRA, for example, should an employee qualify for it. The cost for the insurance product, over a period of time, may be considered minimal as compared to the relatively high cost of the full insurance premiums for COBRA coverage if needed or desired.

Various embodiments of the present disclosure introduce approaches for automated risk assessment for continuation events. The automated risk assessment may ingest information from a variety of data sources and train machine learning models to ascertain corresponding levels of risk associated with employers, employees (e.g., current or former employees), or both employers and employees with respect to continuation events. Such data sources may include industry economic trend data, state unemployment insurance data, department of labor statistic data, social network data, news data, personal credit (e.g., FICO) score data, driver history data, education and level of education data, and so on. A number of examples are outlined below in the context of health insurance, the election for continued coverage under the health insurance plan of a former employer, and the assessment of the likelihood that such an election may or will occur over some period of time. The automated assessments described herein are not limited to use in the context of health insurance coverage or COBRA coverage, however. The automated assessment techniques gather and process data and are applicable to assessments for a range of different needs and fields.

Aspects of the embodiments extend and improve the operations and performance of networked computing systems for the automated identification and assessment of employment-related events occurring (e.g., voluntary or involuntary job loss, the creation of job openings, statistically significant changes in the employment composition of organizations, etc.), the likelihood and extent of such events occurring, and the likelihood and extent of continuation events occurring. The extension and improvement of the operations of the computing systems can include: (1) improving the performance of the computer systems by identifying risk patterns in new types of data structures and data metrics; (2) improving the performance of the computer systems through the generation of the new data structures and data metrics risks; (3) improving the performance of the computer systems in ingesting data from a plurality of different sources to generate the new data structures and assess risk and related metrics with the structures; and so forth.

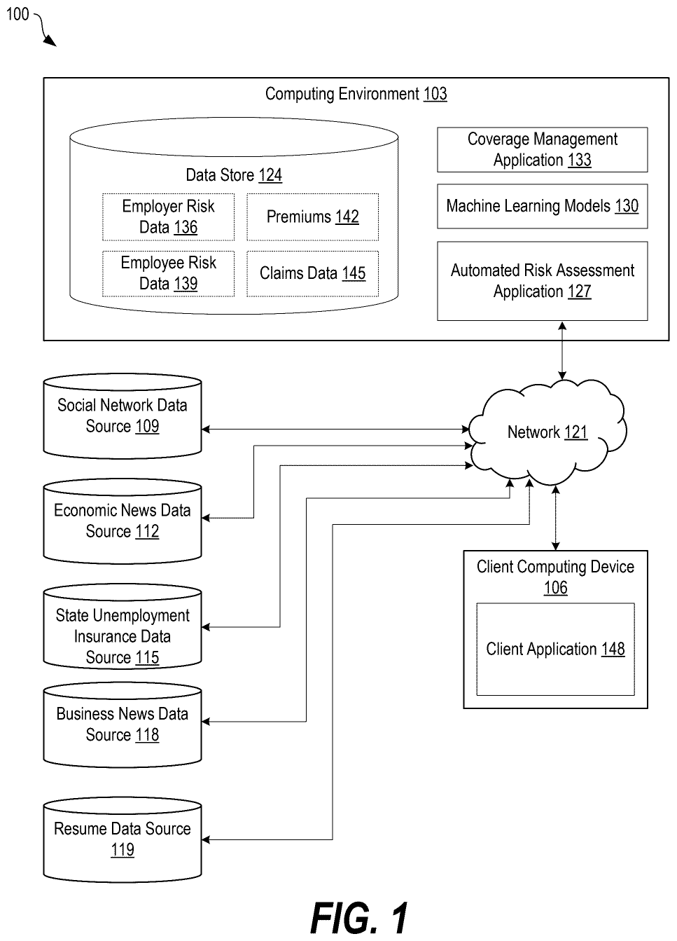

FIG. 1 illustrates an example networked environment 100 for automated continuation event assessment. The networked environment 100 includes a computing environment 103, one or more client computing devices 106, a network 121, and a number of data sources. In the example shown, the data sources include one or more social network data sources 109, one or more economic news data sources 112, one or more state unemployment insurance data sources 115, one or more business news data sources 118, and one or more resume data sources 119. The computing environment 103 and the client computing devices 106 can access and are in data communication with the data sources via the network 121. The network 121 includes, for example, the Internet, intranets, extranets, wide area networks (WANs), local area networks (LANs), wired networks, wireless networks, cable networks, satellite networks, or other suitable networks, etc., or any combination of two or more such networks.

The computing environment 103 may be embodied as a server computer or related computing system providing computing capability. The computing environment 103 may employ a plurality of computing devices arranged in one or more server banks, computer banks, or other arrangement. Such computing devices may be located in a single installation or may be distributed among many different geographical locations. For example, the computing environment 103 may include a plurality of computing devices implemented as a hosted computing resource, a grid computing resource, and/or any other distributed computing arrangement. In some cases, the computing environment 103 may correspond to an elastic computing resource where the allotted capacity of processing, network, storage, or other computing-related resources may vary over time.

A number of applications, services, processes, and related components may be executed in the computing environment 103 according to various embodiments. Also, a range of different data, datatypes, etc. is stored in a data store 124 accessible to the computing environment 103. The data store 124 may be representative of a plurality of data stores 124 as can be appreciated. The data stored in the data store 124, for example, is associated with the operation of the various applications and/or functional entities described below.

As shown in FIG. 1, the computing environment 103 executes an automated risk assessment application 127, one or more machine learning models 130, a coverage management application 133, and possibly other applications, services, processes, systems, engines, or components. The automated risk assessment application 127 is executed to obtain data from a variety of data sources (e.g., digital sources, digital platforms) and automatically determine risk scores associated with continuation events. In one example, the risk scores may then be used to determine premiums for insurance products that cover the continuation events. In this example, the premium values may then accurately reflect the level of risk associated with a claim for a continuation event. In other examples, the risk scores may be used to define one or more terms of some other type of product, contract, or system associated with the continuation events. The automated risk assessment application 127 may obtain data from the data sources by way of application programming interfaces (API), scraping data from web pages, and/or other approaches, and from data previously stored in the environment. The automated risk assessment application 127 may obtain data from the data sources on a continuous (e.g., in real-time, uninterrupted) or periodically according to a defined time interval (e.g., once per day, month, week, and so on).

In automatically determining the risk scores, the automated risk assessment application 127 may train and utilize one or more machine learning models 130. The machine learning models 130 may be trained on a variety of data in order to ascertain patterns in the data through regression analysis. For example, the machine learning models 130 may determine that a certain type of news associated with an industry, or a specific employer may be associated with a higher risk of involuntary termination events for employees, and consequently a higher risk of claims for an insurance product covering continuation events. The machine learning models 130 may be continuously or periodically updated based upon new information, thereby further refining and improving the machine learning models 130. For instance, the machine learning models 130 may be updated with data that is continuously or periodically obtained by the automated risk assessment application 127 from one or more data sources. In some cases, the automated risk assessment application 127 can then use the machine learning models 130 to automatically determine updated risk scores associated with any previously evaluated continuation event based on new information obtained by the automated risk assessment application 127 during a recent search. In other examples, the automated risk assessment application 127 can then use the machine learning models 130 to automatically determine risk scores associated with any potential or new continuation event that may be identified based on new information obtained by the automated risk assessment application 127 during a recent search.

The coverage management application 133 is executed to provide one or more user interfaces for establishing coverage for continuation events, modifying existing coverage, filing claims for continuation events, and/or other functions relating to continuation event coverage. The coverage management application 133 may also generate record data that also feeds into and improves the machine learning models 130.

The data stored in the data store 124 includes, for example, employer risk data 136, employee risk data 139, employee medical premiums 142, claims data 145, and potentially other data. The employer risk data 136 may indicate the risk scores associated with an employer with respect to how many and/or how frequently employees are terminated or otherwise leave the employer, how many of those employees are eligible for and elect COBRA, how long COBRA coverage typically is in force for those employees, and other information. The employee risk data 139 may include the risk scores associated with a certain individual or employee in some cases or with specific groups of individuals or employees in other cases. Examples of the employee risk data 139 include, but are not limited to, length of stay in a given employment position, estimated remaining stay in a given employment position, previous COBRA election history, previous COBRA coverage duration, previous payments to or ownership interest in an existing COBRA coverage, and/or other information.

The premiums 142 may be calculated for a certain individual or employee in one example based upon data in the employee risk data 139 that pertains to such an individual or employee. In another example, the premiums 142 may be calculated for a group plan based upon the aggregation of data in the employee risk data 139 that pertains to a certain group such as, for instance, a specific group of individuals or employees. The claims data 145 may record quantity and frequency of COBRA claims, how long COBRA coverage is in force, and/or other data.

The client computing device 106 is representative of one of a plurality of client devices that may be coupled to the network 121. The client computing device 106 may include or be embodied as, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client computing device 106 may include a display device such as, for example, one or more liquid crystal displays (LCD), gas plasma-based flat panel displays, organic light emitting diode (OLED) displays, electrophoretic ink (E ink) displays, LCD projectors, or other types of display devices, etc.

The client computing device 106 may be configured to execute various applications such as a client application 148 and/or other applications. The client application 148 may be executed in a client computing device 106, for example, to access network content served up by the computing environment 103 and/or other servers, thereby rendering a user interface on the display. To this end, the client application 148 may include or be embodied as, for example, a browser, a dedicated application, etc., and the user interface may include or be embodied as a network page, an application screen, etc. The client application 148 may be used to interact with the coverage management application 133 to perform various functions including obtaining pricing for coverage, establishing coverage, adding or removing employees to the coverage, making claims, and/or other functions. The client computing device 106 may be configured to execute applications beyond the client application 148 such as, for example, email applications, digital platform applications (e.g., social media or networking applications), word processors, spreadsheets, and/or other applications.

The automated risk assessment application 127 may refer to a variety of data sources, including a social network data source 109, an economic news data source 112, a state employment insurance data source 115, a business news data source 118, a resume data source 119, and/or other data sources. The social network data source 109 may provide publicly available data from social networks, such as LINKEDIN and FACEBOOK. In some examples, a social network may provide data identifying current employees at a given employer (e.g., employee's profiles refer to their current employer), and a social network may also indicate a given individual's employment history (e.g., past employers, gaps between employment with past employers, longevity with current employer, and so on). Other types of data can be accessible to the automated risk assessment application 127 in some cases. For example, Department of Labor statistics, personal credit (e.g., FICO) scores and data, driver history data, education and level of education data, and other types of data can be accessed by the automated risk assessment application 127.

The economic news data source 112 may provide news data related to economic factors affecting various industries. From this economic news data, it can be determined whether an industry segment of an employer is doing well or faring poorly. Trends for future performance can also be predicted. For example, a specific industry sector may be predicted to contract within the next year and lay off a certain percentage of its workforce relating to downsizing. As another example, a specific industry second may be predicted to grow and add new positions to its workforce. As yet another example, a specific industry sector may be economically doing well but employers in the sector may be predicted to downsize their workforces due to outsourcing or new technology efficiencies.

The state unemployment insurance data source 115 may provide information about past unemployment insurance claims associated with specific employers or classes of employees by profession or other differentiation. The state unemployment insurance data source 115 may include information about whether employee separations were with cause or without cause. In various scenarios, the state unemployment insurance data source 115 may provide an unemployment tax rate based upon the employer's history, with new employers lacking an established history paying more than employers with a long-term track record of no involuntary separations, and employers having frequent involuntary separations without cause having the highest tax rates.

The business news data source 118 may provide news information in regard to specific employers or industries. In some examples, the business news data source 118 may include press releases. The business news may indicate that a certain employer is expanding its workforce, or conversely, reducing its workforce.

The resume data source 119 may include resume data for various employees. Such resume data may be provided by the employer or employee or may be aggregated from a resume forwarding site (e.g., a job board). The resume data may indicate lengths of time that an individual typically stays in a job, lengths of time that an individual is unemployed between jobs, information indicating education and experience that can be used to predict a likelihood of the individual finding a replacement job within a time frame, and so on.

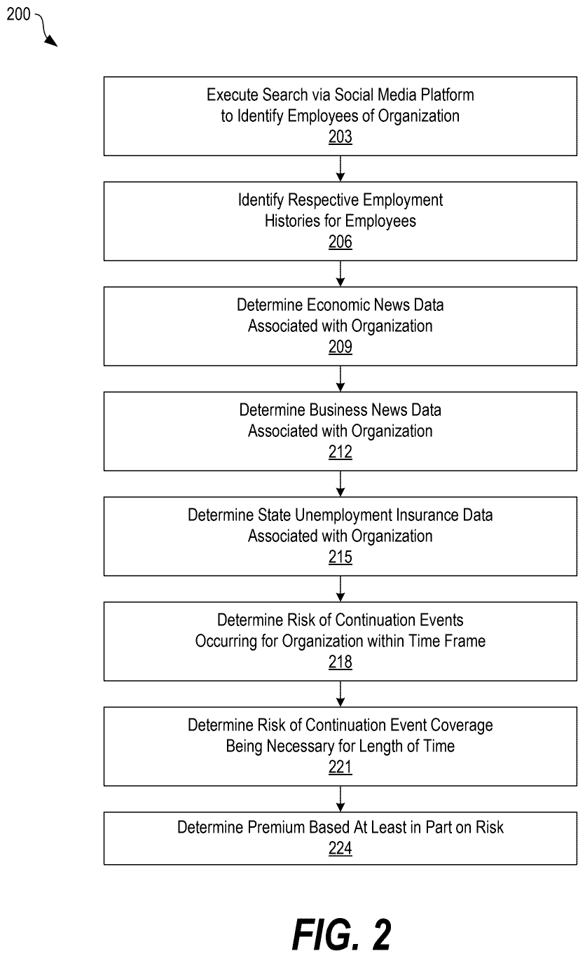

Referring next to FIG. 2, shown is a flowchart that provides one example of the operation of a portion of the automated risk assessment application 127 according to various embodiments. It is understood that the flowchart of FIG. 2 provides merely an example of the many different types of functional arrangements that may be employed to implement the operation of the portion of the automated risk assessment application 127 as described herein. As an alternative, the flowchart of FIG. 2 may be viewed as depicting an example of elements of a method implemented in the computing environment 103 (FIG. 1) according to one or more embodiments.

Beginning with box 203, the automated risk assessment application 127 may execute a search via a social media platform to identify one or more employees of an organization. The organization or an employee thereof may request continuation event coverage, such as insurance coverage for COBRA premiums. For example, the automated risk assessment application 127 may execute a query on the social network data source 109 (FIG. 1) for all profiles listing the organization as a current employer. Alternatively, the automated risk assessment application 127 may obtain a list of employees from the employer. As used herein, employees may include individuals, executive and non-executive employees, owners, and/or independent contractors who have a relationship with the organization, such as would enable them to be on a group health insurance plan of the organization.

In box 206, the automated risk assessment application 127 may identify respective employment histories for the employees of the organization. For example, the automated risk assessment application 127 may query the social media profiles of the employees via the social network data source 109 to determine a list of positions at various organizations worked and durations. In another example, the employment histories may be determined from resumes obtained from the resume data source 119 (FIG. 1).

In box 209, the automated risk assessment application 127 may determine economic news data from one or more economic news data sources 112 (FIG. 1). The economic news data may reveal positive or negative trends associated with a specific industry or sector of the organization that may be predictive of whether the organization is likely to have continuation events (e.g., layoffs, downsizing, outsourcing, etc.).

In box 212, the automated risk assessment application 127 may determine business news data associated with the organization from one or more business news data sources 118 (FIG. 1). For example, the business news data may indicate that the organization is about to hire new employees or downsize, or that the organization has done so in the past.

In box 215, the automated risk assessment application 127 may determine state unemployment insurance data associated with the organization from the state unemployment insurance data source 115 (FIG. 1). The data may include other information that goes into computing the tax rate.

In box 218, the automated risk assessment application 127 may determine a risk score for one or more continuation events occurring within a time frame. In this regard, the automated risk assessment application 127 may use one or more machine learning models 130 trained on the various data, such as social network data, economic news, state unemployment insurance data, business news data, resume data, and so on, in view of claims data 145 (FIG. 1), to determine what types of events are associated with COBRA coverage claims.

In box 221, the automated risk assessment application 127 may determine a risk score for continuation event coverage being necessary or maintained for a length of time. For example, the risk may be assessed for, and the risk score may be based on, a frequency of one month coverage, three months coverage, six months coverage, one year coverage, eighteen months coverage, or other time periods. If employees are likely to stay on COBRA longer, the risk and therefore the risk score and the cost associated with providing an insurance product covering COBRA will each be higher.

In box 224, the automated risk assessment application 127 determines the premiums 142 (FIG. 1) for a continuation coverage product based at least in part on a risk score for a continuation event occurring and/or continuation coverage being necessary for a certain period of time. In various scenarios, the continuation coverage product may include one or more of continuation of mortgage payments for a limited period of time, with the mortgage lender offering the insurance as part of monthly payments, covering rent payments for a limited period of time, covering student loan payments for a limited period of time, and so on. Thereafter, the operation of the portion of the automated risk assessment application 127 ends.

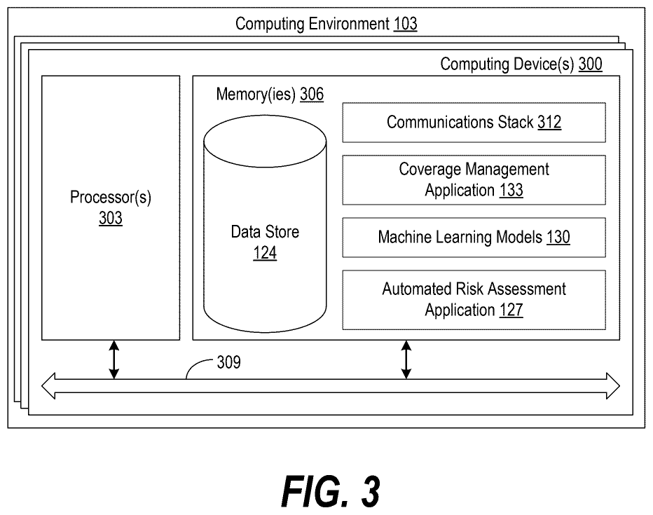

With reference to FIG. 3, shown is a schematic block diagram of the computing environment 103 according to an embodiment of the present disclosure. The computing environment 103 includes one or more computing devices 300. Each computing device 300 includes at least one processor circuit, for example, having a processor 303 and a memory 306, both of which are coupled to a local interface 309. To this end, each computing device 300 may be embodied as or include, for example, at least one server computer or like device. The local interface 309 may be embodied as or include, for example, a data bus with an accompanying address/control bus or other bus structure as can be appreciated.

Stored in the memory 306 are both data and several components that are executable by the processor 303. In particular, stored in the memory 306 and executable by the processor 303 are the automated risk assessment application 127, the machine learning models 130, the coverage management application 133, a communications stack 312, and potentially other applications. Also stored in the memory 306 may be a data store 124 and other data. In addition, an operating system may be stored in the memory 306 and executable by the processor 303.

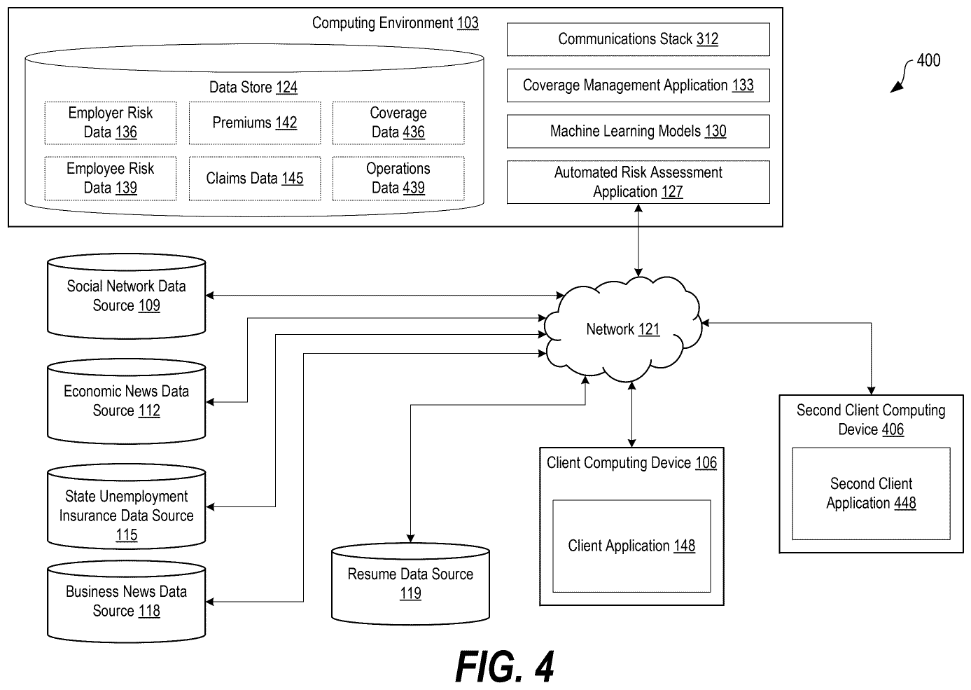

The communications stack 312 can include software and hardware layers to implement data communications such as, for instance, Bluetooth®, Bluetooth® Low Energy (BLE), WiFi®, cellular data communications interfaces, or a combination thereof. Thus, the communications stack 312 can be relied upon by the computing device 300 to establish cellular, Bluetooth®, WiFi®, and other communications channels with the networks 121 and with at least one of the client computing device 106 or another computing device or system described herein (e.g., a second client computing device 406 described below with reference to FIG. 4 and/or a device of each of the data sources 109, 112, 115, 118, 119).

The communications stack 312 can include the software and hardware to implement Bluetooth®, BLE, and related networking interfaces, which provide for a variety of different network configurations and flexible networking protocols for short-range, low-power wireless communications. The communications stack 312 can also include the software and hardware to implement WiFi® communication, and cellular communication, which also offers a variety of different network configurations and flexible networking protocols for mid-range, long-range, wireless, and cellular communications. The communications stack 312 can also incorporate the software and hardware to implement other communications interfaces, such as X10®, ZigBee®, Z-Wave®, and others. The communications stack 312 can be configured to communicate various data or information amongst the computing device 300 and any other computing device or system described herein (e.g., the client computing device 106, a second client computing device 406 described herein with reference to FIG. 4, and/or a device of each of the data sources 109, 112, 115, 118, 119). Examples of such data or information can include, but are not limited to, at least one of the employer risk data 136, the employee risk data 139, the employee medical premiums 142, or the claims data 145 described herein, among other data (e.g., coverage data 436 and/or operations data 439 described herein with reference to FIG. 4).

It is understood that there may be other applications that are stored in the memory 306 and are executable by the processor 303 as can be appreciated. Where any component discussed herein is implemented in the form of software, any one of a number of programming languages may be employed such as, for example, C, C++, C #, Objective C, Java®, JavaScript®, Perl, PHP, Visual Basic®, Python®, Ruby, Flash®, or other programming languages.

A number of software components are stored in the memory 306 and are executable by the processor 303. In this respect, the term “executable” means a program file that is in a form that can ultimately be run by the processor 303. Examples of executable programs may be, for example, a compiled program that can be translated into machine code in a format that can be loaded into a random access portion of the memory 306 and run by the processor 303, source code that may be expressed in proper format such as object code that is capable of being loaded into a random access portion of the memory 306 and executed by the processor 303, or source code that may be interpreted by another executable program to generate instructions in a random access portion of the memory 306 to be executed by the processor 303, etc. An executable program may be stored in any portion or component of the memory 306 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 306 is defined herein as including both volatile and nonvolatile memory and data storage components. Volatile components are those that do not retain data values upon loss of power. Nonvolatile components are those that retain data upon a loss of power. Thus, the memory 306 may be embodied as or include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may be embodied as or include, for example, static random-access memory (SRAM), dynamic random-access memory (DRAM), or magnetic random-access memory (MRAM) and other such devices. The ROM may be embodied as or include, for example, a programmable read-only memory (PROM), an erasable programmable read-only memory (EPROM), an electrically erasable programmable read-only memory (EEPROM), or other like memory device.

Also, the processor 303 may represent multiple processors 303 and/or multiple processor cores and the memory 306 may represent multiple memories 306 that operate in parallel processing circuits, respectively. In such a case, the local interface 309 may be an appropriate network that facilitates communication between any two of the multiple processors 303, between any processor 303 and any of the memories 306, or between any two of the memories 306, etc. The local interface 309 may include additional systems designed to coordinate this communication, including, for example, performing load balancing. The processor 303 may be of electrical or of some other available construction.

Although the automated risk assessment application 127, the machine learning models 130, the coverage management application 133, the client application 148, and the communications stack 312, as well as a second client application 448 described herein with reference to FIG. 4 and other various systems described herein, may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

FIG. 4 illustrates a block diagram of another example networked environment 400 in accordance with at least one embodiment of the present disclosure. The networked environment 400 is an example alternative embodiment of the networked environment 100 described above and illustrated in FIG. 1.

A difference between the networked environment 400 and the networked environment 100 is that the networked environment 400 includes one or more second client computing devices 406 respectively in data communication with any or all of the computing environment 103, the client computing devices 106, the social network data sources 109, the economic news data sources 112, the state unemployment insurance data sources 115, the business news data sources 118, and the resume data sources 119 via the network 121. Another difference between the networked environment 400 and the networked environment 100 is that the data store 124 of the networked environment 400 further includes coverage data 436 and operations data 439, among possibly other data.

The second client computing device 406 is representative of one of a plurality of second client devices that may be coupled to the network 121. The second client computing device 406 may include or be embodied as, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The second client computing device 406 may include a display device such as, for example, one or more liquid crystal displays (LCD), gas plasma-based flat panel displays, organic light emitting diode (OLED) displays, electrophoretic ink (E ink) displays, LCD projectors, or other types of display devices, etc.

In some cases, the second client computing device 406 may be embodied or implemented, at least in part, as one of the computing devices 300 described above and illustrated in FIG. 3. In other examples, at least one subset of the second client computing devices 406 may be embodied or implemented, at least in part, as the computing environment 103. For instance, the second client computing devices 406 may individually or collectively include at least some of the same components, attributes, and functionality as that of the computing device 300 and/or the computing environment 103. However, in some examples, one or more of the automated risk assessment application 127, the machine learning models 130, the coverage management application 133, the employer risk data 136, the employee risk data 139, the premiums 142, and the claims data 145 may be omitted from one or more of the second client computing devices 406.

Additionally, any or all of the second client computing devices 406 may be respectively associated with and operated by or on behalf of different organizations. For instance, any or all individual or subsets of the second client computing devices 406 may be respectively associated with and operated by or on behalf of different third-party organizations (e.g., service or product providers) that operate independently from an organization, employer, or employee associated with one or more of the computing environment 103, the client computing devices 106, and the computing devices 300.

In the example shown in FIG. 4, the second client computing device 406 is configured to include and execute a second client application 448, among possibly other applications. In this example, the second client application 448 is in data communication with at least one of the automated risk assessment application 127, the machine learning models 130, the coverage management application 133, or the communications stack 312. The second client application 448 may be executed by the second client computing device 406, for example, to access network content and/or implement instructions served up by the computing environment 103 and/or other servers, thereby rendering a user interface on the display device of the second client computing device 406. To this end, the second client application 448 may include or be embodied as, for example, a browser, a dedicated application, etc., and the user interface may include or be embodied as a network page, an application screen, an application programming interface (API), etc. The second client application 448 may be used to interact and communicate with at least one of the automated risk assessment application 127, the machine learning models 130, the coverage management application 133, or the communications stack 312 of the computing environment 103 to perform various functions described in examples herein. Additionally, the second client computing device 406 may be configured to execute applications beyond the second client application 448 such as, for example, email applications, digital platform applications (e.g., social media or networking applications), word processors, spreadsheets, and/or other applications.

The coverage data 436 may include continuation event coverage data associated with a certain individual or employee in some cases or with specific groups of individuals or employees in other cases. For instance, the coverage data 436 may include data indicative of past or current continuation event coverage elected by an individual, employee or group of individuals or employees. For example, the coverage data 436 may include data indicative of the type of continuation event coverage elected (e.g., COBRA coverage), the amounts and number of premium payments made for the coverage, the ownership interest of an individual, employee, or group of individuals or employees in the coverage, and/or other data. Some or all of the coverage data 436 may be obtained from public data sources in some cases or from private data sources in other examples. In one example, some or all of the coverage data 436 may be obtained by requesting it from an individual, employee, group of individuals or employees, organization, third-party organization, or another entity associated with or operating at least one of the networked environment 400, the computing environment 103, the client computing device 106, or the second client computing device 406.

The operations data 439 may include various computer-executable instructions or components that, when executed by the second client computing device 406 via the second client application 448, cause the second client computing device 406 to perform one or more operations described herein based on risk scores calculated by the automated risk assessment application 127 for potential continuation events occurring. The operations data 439 may include, for instance, if-then statements that respectively correspond to different levels of risk of a potential continuation event occurring. The if-then statements may also respectively correspond to certain instructions or workflows that can be implemented by the second client computing device 406 via the second client application 448 to perform various operations described herein based on different risk scores calculated for different potential continuation events occurring. In one example, a gold level of risk may denote a relatively low level of risk that the event will occur and a relatively low risk score, a silver level of risk may denote a relatively moderate level of risk that the event will occur and a relatively moderate risk score, and a bronze level of risk may denote a relatively high level of risk that the event will occur and a relatively high risk score.

In the example illustrated in FIG. 4, the computing environment 103 can employ one or more of the computing devices 300 to execute a search via at least one digital platform having digital data associated with at least one of an organization or an employee of the organization. For instance, the computing devices 300 of the computing environment 103 can implement the automated risk assessment application 127 to execute a search of any or all of the social network data sources 109, the economic news data sources 112, the state unemployment insurance data sources 115, the business news data sources 118, and the resume data sources 119, among other data sources as described herein. The computing environment 103 (e.g., via the computing devices 300 and the automated risk assessment application 127) can execute the search in this example to identify data indicative of a potential continuation event associated with at least one of the organization or the employee. The data indicative of the potential continuation event may include, but is not limited to, at least one of employment history data of the employee, economic news data indicating one or more economic trends associated with the organization, news data indicating one or more employee downsizing events by the organization, state unemployment insurance data associated with the organization and/or industry, or resume data of the employee.

The computing environment 103 can further employ one or more of the computing devices 300 to determine, using a machine learning model and based at least in part on the data, a risk score indicating a likelihood the potential continuation event will occur within a certain time frame. For instance, the computing devices 300 can implement the machine learning models 130 using the data indicative of such a potential continuation event to determine a risk score indicating the likelihood the potential continuation event will actually occur within a certain time frame. To achieve this, the computing devices 300 can use the machine learning models 130 to, for instance, weight the data based on one or more factors. Example factors include, but are not limited to, at least one of data type, content of the data, trustworthiness of the data source or sources from which the data are obtained, age of the data, or relevance to the potential continuation event, among other factors. For instance, newer data may be assigned a higher weight value compared to older data, resume data obtained from the resume data source 119 may be assigned a higher weight value compared to employment data obtained from the social network data source 109, etc.

In the example shown in FIG. 4, the computing environment 103 (e.g., using the computing devices 300 and the automated risk assessment application 127) can also execute iterative searches via any or all of the digital platforms described above. For instance, the computing environment 103 can execute iterative searches of such digital platforms to identify additional or new data indicative of at least one of a previously identified potential continuation event or a newly identified potential continuation event associated with at least one of the organization or the employee.

In examples where the computing environment 103 identifies additional data indicative of a previously identified potential continuation event when performing iterative searches of at least one digital platform, the computing environment 103 (e.g., via the computing devices 300 and the machine learning models 130) can use such additional data to update a corresponding previously determined risk score for the event actually occurring within a previously defined time frame and/or within an updated time frame. For instance, the computing environment 103 can use such additional data to determine an updated risk score for the previously identified potential continuation event actually occurring within the previously defined time frame and/or within a different time frame that can be defined by the computing environment 103 based on such additional data. In examples where the computing environment 103 identifies new data indicative of a new potential continuation event when performing iterative searches of at least one digital platform, the computing environment 103 (e.g., via the computing devices 300 and the machine learning models 130) can use such new data to determine a risk score for the newly identified potential continuation event occurring within some new or updated time frame that can be defined by the computing environment 103 based on such new data.

In the example illustrated in FIG. 4, the computing environment 103 (e.g., via the computing devices 300 and the automated risk assessment application 127) can determine a risk score for continuation event coverage being necessary in connection with existing continuation event coverage for an individual, employee, or a group of individuals or employees. For instance, the computing environment 103 can determine a risk score indicating a likelihood the existing continuation event coverage will be used by the individual, employee, or group of individuals or employees based at least in part on ownership interest of the individual, employee, or group of individuals or employees in the existing continuation event coverage. For example, in advance of some potential continuation event, an employee of an organization may obtain continuation event coverage for the potential continuation event. To obtain the coverage for the potential event, the employee may pay a lump sum premium or multiple premium payments over some period of time. Once the employee has paid 100% of the total cost of the continuation event coverage, the employee will have a 100% ownership interest in the coverage. At that point, the employee can elect to implement the continuation event coverage upon the occurrence of the potential continuation event without paying any further premiums.

As such, in some cases, the computing environment 103 (e.g., via the computing devices 300 and the automated risk assessment application 127) can determine that a relatively high ownership interest in the existing continuation event coverage corresponds to a relatively high likelihood that the employee will elect to implement such coverage upon the occurrence of the potential continuation event. In these cases, the computing environment 103 can further determine that such a relatively high likelihood that the employee will elect to implement the existing continuation event coverage upon the occurrence of the potential continuation event corresponds to a relatively high risk of such existing continuation event coverage being necessary, and thus, a relatively high risk score. In one example, the computing environment 103 can determine that the risk score for such existing continuation event coverage being necessary is directly proportional to the ownership interest. To determine the ownership interest in existing continuation event coverage, in some cases, the computing environment 103 (e.g., via the computing devices 300 and the automated risk assessment application 127) can rely on past or present continuation event coverage data. For instance, the computing environment 103 can rely on past or present continuation event coverage data obtained from at least the coverage data 436.

In the example depicted in FIG. 4, the computing environment 103 (e.g., via the computing devices 300 and the automated risk assessment application 127) can determine a risk score for continuation event coverage being necessary for a certain length of time for an individual, an employee, or a group of individuals or employees. For example, the computing environment 103 can determine a risk score indicating a likelihood the continuation event coverage will be used by the individual, employee, or group of individuals or employees based at least in part on one or more employment gaps in which the individual, employee, or group of individuals or employees previously elected to implement the same type or a different type of continuation event coverage.

In some examples, the computing environment 103 (e.g., via the computing devices 300 and the automated risk assessment application 127) can determine that identification of one or more employment gaps in which an individual, an employee, or a group of individuals or employees previously elected to implement a certain type of continuation event coverage following a previous continuation event corresponds to a certain risk score for the same or a different type of continuation event coverage being necessary following another of the same or a different type of continuation event. For instance, the computing environment 103 can determine that the risk score for the continuation event coverage being necessary for a certain length of time is directly proportional to the number of employment gaps during which the previous continuation coverage was implemented by the individual, employee, or group of individuals or employees. For example, the risk and the risk score each being relatively higher for a higher number of previous implementations of the same or different type of continuation event coverage compared to that being evaluated and relatively lower for a lower number of previous implementations.

In other examples, the computing environment 103 (e.g., via the computing devices 300 and the automated risk assessment application 127) can determine that the risk score for the continuation event coverage being necessary for a certain length of time is correlated with the type of continuation coverage that was previously implemented by the individual, employee, or group of individuals or employees during one or more employment gaps. For instance, the risk and the risk score each being relatively higher for previous implementation of the same type of continuation coverage as that being evaluated and relatively lower for previous implementation of different continuation coverage compared to the coverage being evaluated.

In other examples, the computing environment 103 (e.g., via the computing devices 300 and the automated risk assessment application 127) can determine a risk score for continuation event coverage being necessary for a length of time that corresponds to an average amount of time during which an individual, an employee, or a group of individuals or employees previously elected to implement the same or different type of continuation coverage following a continuation event. For instance, the computing environment 103 can determine that the risk score for the continuation event coverage being necessary for such a length of time is directly proportional to the average amount of time during which the previous continuation coverage was implemented by the individual, employee, or group of individuals or employees. For example, the risk and the risk score each being relatively higher for longer implementation periods of the same or different type of continuation coverage as that being evaluated and relatively lower for shorter implementation periods.

To identify one or more employment gaps in which an individual, an employee, or a group of individuals or employees previously elected to implement a certain type of continuation event coverage following a previous continuation event, in some cases, the computing environment 103 (e.g., via the computing devices 300 and the automated risk assessment application 127) can rely on employment history data and continuation event coverage data. For instance, the computing environment 103 can rely on employment history data and continuation event coverage data obtained from at least one of the social network data sources 109, the state unemployment insurance data sources 115, the resume data sources 119, or the coverage data 436.

In the example shown in FIG. 4, the computing environment 103 (e.g., via the computing devices 300, the automated risk assessment application 127, the client application 148, and/or the second client application 448) can cause one or more second computing devices to respectively perform at least one operation associated with at least one of an individual, an employee, a group of individuals or employees, or an organization based on a certain risk score calculated for a certain potential continuation event occurring. In some examples, any or all of such second computing devices may be associated with one or more different entities such as, for instance, the individual, employee, group of individuals or employees, the organization, a third-party entity (e.g., a service or product provider), or another entity.

In one example, the computing environment 103 can cause at least one of the client computing device 106 or the second client computing device 406 to perform at least one operation associated with at least one of an individual, an employee, a group of individuals or employees, or an organization based on a certain risk score calculated for a certain potential continuation event occurring. In another example, the computing environment 103 can concurrently cause multiples of at least one of the client computing device 106 or the second client computing device 406 to respectively perform at least one operation associated with at least one of an individual, an employee, a group of individuals or employees, or an organization based on a certain risk score calculated for a certain potential continuation event occurring.

To cause at least one of the client computing devices 106 or the second client computing devices 406 to perform an operation based on a risk score determined as described herein, the computing environment 103 can be configured to send one or more certain portions of the operations data 439 to one or more certain client computing devices 106 or second client computing devices 406 based on a certain risk score corresponding to such portions of the operations data 439. Based on receipt of such data, these one or more certain client computing devices 106 or second client computing devices 406 can be configured to automatically execute computer-executable instructions or workflows of such portion or portions of the operations data 439 to perform one or more specific operations.

In one example, based on a relatively high risk score for a certain potential continuation event occurring, the computing environment 103 can cause at least one of the second client computing devices 406 to implement some workflow such as, for example, generating a certain contract or product that corresponds to such a relatively high risk score and is associated with certain continuation event coverage for the potential event. In some cases, the computing environment 103 can further cause the at least one second client computing device 406 to send a message to the client computing device 106 recommending such a certain contract or product to an individual or an employee (e.g., a current or former employee) associated with the client computing device 106.

In some cases, the second client computing device 406 may be associated with and/or operated by or on behalf of a third-party organization that provides services or products that are valued based at least in part on some risk assessment performed by the third-party organization. For instance, the third-party organization may provide services or products that are designed to protect against the occurrence of the continuation event or a consequence thereof (e.g., a former employee's inability to pay COBRA premiums, rent payments, student loan payments, or mortgage payments, among others). In some examples, the computing environment 103 can be configured to facilitate the risk assessment and product or service valuation process performed by the third-party organization. For instance, the computing environment 103 (e.g., via the computing devices 300, the automated risk assessment application 127, and the second client application 448) can be configured to convert a risk score calculated by the automated risk assessment application 127 to a corresponding risk score of a risk assessment system used by the third-party organization. In another example, the computing environment 103 can be configured to convert a digital format of a risk score calculated by the automated risk assessment application 127 to another digital format utilized by the risk assessment system of the third-party organization. For instance, the computing environment 103 can be configured to convert a file format of a risk score calculated by the automated risk assessment application 127 to another file format utilized by the risk assessment system of the third-party organization.

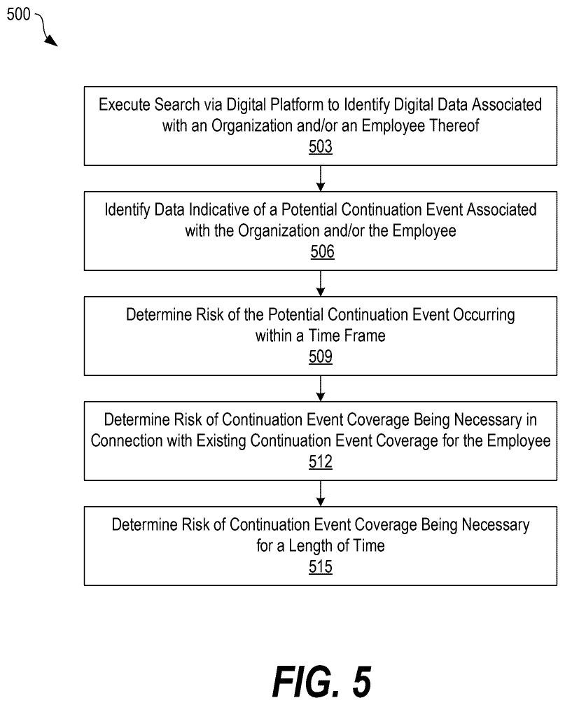

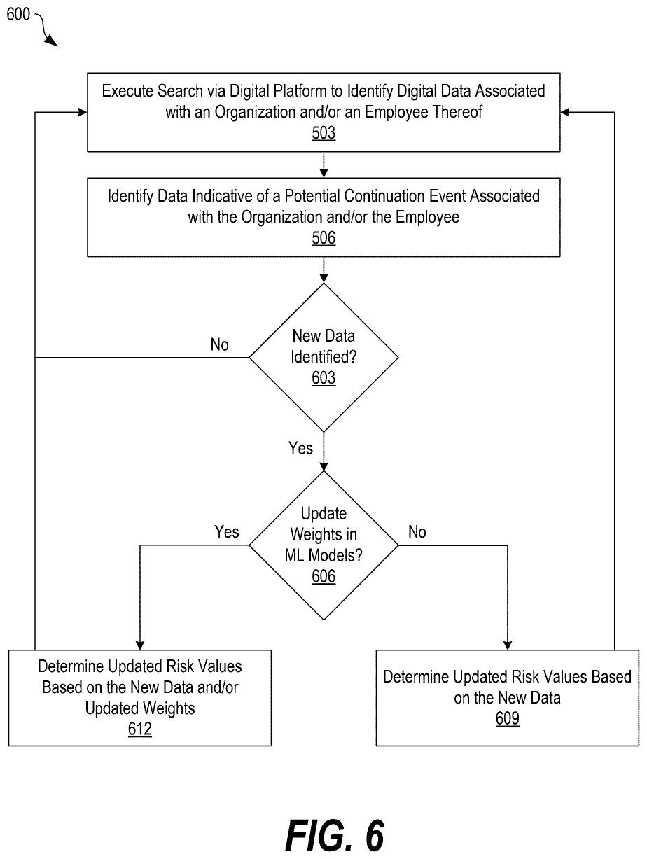

FIG. 5 illustrates a flowchart of another example method 500 for assessing risk associated with continuation events in accordance with at least one embodiment of the present disclosure. Shown in FIG. 5 is a flowchart that provides one example of the operation of a portion of the automated risk assessment application 127 according to various embodiments. It is understood that the flowchart of FIG. 5 provides merely an example of the many different types of functional arrangements that may be employed to implement the operation of the portion of the automated risk assessment application 127 as described herein. As an alternative, the flowchart of FIG. 6 may be viewed as depicting an example of elements of a method implemented in the computing environment 103 of at least one of the networked environment 100 (FIG. 1) or the networked environment 400 (FIG. 4) according to one or more embodiments.

Beginning with box 503, execute a search via at least one digital platform having digital data associated with an organization and/or an employee of the organization. In one example, the automated risk assessment application 127 can execute a search of any or all of the social network data sources 109, the economic news data sources 112, the state unemployment insurance data sources 115, the business news data sources 118, and the resume data sources 119, among other data sources as described herein. In this example, the automated risk assessment application 127 can further execute a search via one or more public or private data sources (e.g., databases) to obtain some or all of the coverage data 436. In some cases, the automated risk assessment application 127 can obtain some or all of the coverage data 436 by requesting it from an individual, employee, group of individuals or employees, organization, third-party organization, or another entity associated with or operating at least one of the networked environment 400, the computing environment 103, the client computing device 106, or the second client computing device 406. In this example, the coverage data 436 includes data indicative of past or current continuation event coverage elected by an individual, employee or group of individuals or employees.

In one example, the automated risk assessment application 127 may execute a search via a social media platform to identify one or more employees of an organization. The organization or an employee thereof may request continuation event coverage, such as insurance coverage for COBRA premiums. For example, the automated risk assessment application 127 may execute a query on the social network data source 109 (FIG. 1) for all profiles listing the organization as a current employer. Alternatively, the automated risk assessment application 127 may obtain a list of employees from the employer, as well as some or all of the coverage data 436. The automated risk assessment application 127 may also identify respective employment histories for the employees of the organization in this example. For instance, the automated risk assessment application 127 may query the social media profiles of the employees via the social network data source 109 to determine a list of positions at various organizations worked and durations or the employment histories may be determined from resumes obtained from the resume data source 119 (FIG. 1).

In box 506, the automated risk assessment application 127 can execute the search to identify data indicative of a potential continuation event associated with at least one of the organization or the employee. The data indicative of the potential continuation event may include, but is not limited to, at least one of employment history data of the employee, economic news data indicating one or more economic trends associated with the organization, news data indicating one or more employee downsizing events by the organization, state unemployment insurance data associated with the organization, or resume data of the employee.

In this example, the automated risk assessment application 127 may determine economic news data from one or more economic news data sources 112 (FIG. 1). The economic news data may reveal positive or negative trends associated with a specific industry or sector of the organization that may be predictive of whether the organization is likely to have continuation events (e.g., layoffs, downsizing, outsourcing, etc.). In this example, the automated risk assessment application 127 may determine business news data associated with the organization from one or more business news data sources 118 (FIG. 1). For example, the business news data may indicate that the organization is about to hire new employees or downsize, or that the organization has done so in the past. In this example, the automated risk assessment application 127 may determine state unemployment insurance data associated with the organization or industry from the state unemployment insurance data source 115 (FIG. 1). The data may include other information that goes into computing the tax rate.

In box 509, the automated risk assessment application 127 may determine the risk score indicating a likelihood of the potential continuation event occurring within a certain time frame. In one example, the automated risk assessment application 127 may use one or more machine learning models 130 trained on the various data, such as social network data, economic news, state unemployment insurance data, business news data, resume data, and so on, in view of the claims data 145 (FIG. 1) and the coverage data 436 (FIG. 4), to determine what types of events are associated with COBRA coverage claims.

In this example, the automated risk assessment application 127 can implement the machine learning models 130 using the data identified in box 506 to determine the risk score for the potential continuation event actually occurring within a certain time frame. To achieve this, the automated risk assessment application 127 can use the machine learning models 130 to, for instance, weight the data based on one or more factors including data type, content of the data, trustworthiness of the data source or sources from which the data are obtained, age of the data, and relevance to the potential continuation event, among other factors. For instance, newer data may be assigned a higher weight value compared to older data, resume data obtained from the resume data source 119 may be assigned a higher weight value compared to employment data obtained from the social network data source 109, etc.

In box 512, the automated risk assessment application 127 can determine a risk score indicating a likelihood of continuation event coverage being necessary in connection with existing continuation event coverage for the employee. For instance, the automated risk assessment application 127 can determine a risk score indicating a likelihood that the existing continuation event coverage will be used by the employee based at least in part on ownership interest of the employee in the existing continuation event coverage. For example, in advance of some potential continuation event, the employee may obtain continuation event coverage for the potential continuation event. To obtain the coverage for the potential event, the employee may pay a lump sum premium or multiple premium payments over some period of time. Once the employee has paid 100% of the total cost of the continuation event coverage, the employee will have a 100% ownership interest in the coverage. At that point, the employee owns the continuation event coverage without the necessity of paying any further premiums. In one example, the automated risk assessment application 127 can determine that the risk score for such existing continuation event coverage being necessary is directly proportional to the employee's ownership interest such that a relatively high ownership interest corresponds to a relatively high risk of the coverage being necessary, and thus, also to a relatively high risk score.

In box 515, the automated risk assessment application 127 may determine a risk score indicating a likelihood for continuation event coverage being necessary or maintained for a length of time. For example, the risk may be assessed for, and the risk score may be based on, a frequency of one month coverage, three months coverage, six months coverage, one year coverage, eighteen months coverage, or other time periods. If employees are likely to stay on COBRA longer, the risk and therefore the risk score and the cost associated with providing an insurance product covering COBRA will each be higher.

In one example, the automated risk assessment application 127 can determine a risk score for continuation event coverage being necessary for a certain length of time for the employee. For example, the automated risk assessment application 127 can determine a risk score indicating a likelihood that continuation event coverage will be used by the employee based at least in part on one or more employment gaps in which the employee previously elected to implement the same type or a different type of continuation event coverage.

In some examples, the automated risk assessment application 127 can determine that the risk score for the continuation event coverage being necessary for the employee for a certain length of time is directly proportional to the number of employment gaps during which the previous continuation coverage was implemented by the employee. For example, the risk and the risk score each being relatively higher for a higher number of previous implementations of the same or different type of continuation event coverage compared to that being evaluated and relatively lower for a lower number of previous implementations.

In other examples, the automated risk assessment application 127 can determine that the risk score for the continuation event coverage being necessary for a certain length of time is correlated with the type of continuation coverage that was previously implemented by the employee during one or more employment gaps. For instance, the risk and the risk score each being relatively higher for previous implementation of the same type of continuation coverage as that being evaluated and relatively lower for previous implementation of different continuation coverage compared to the coverage being evaluated.

In other examples, the automated risk assessment application 127 can determine a risk score indicating a likelihood of continuation event coverage being necessary for a length of time that corresponds to an average amount of time during which the employee previously elected to implement the same or different type of continuation coverage following a continuation event. For instance, the automated risk assessment application 127 can determine that the risk score for the continuation event coverage being necessary for such a length of time is directly proportional to the average amount of time during which the previous continuation coverage was implemented by the employee. For example, the risk and the risk score being relatively higher for longer implementation periods of the same or different type of continuation coverage as that being evaluated and relatively lower for shorter implementation periods.

FIG. 6 illustrates a flowchart of another example method 600 for assessing risk associated with continuation events in accordance with at least one embodiment of the present disclosure. Shown in FIG. 6 is a flowchart that provides one example of the operation of a portion of the automated risk assessment application 127 according to various embodiments. It is understood that the flowchart of FIG. 6 provides merely an example of the many different types of functional arrangements that may be employed to implement the operation of the portion of the automated risk assessment application 127 as described herein. As an alternative, the flowchart of FIG. 6 may be viewed as depicting an example of elements of a method implemented in the computing environment 103 of at least one of the networked environment 100 (FIG. 1) or the networked environment 400 (FIG. 4) according to one or more embodiments. The flowchart of FIG. 6 illustrates an example of at least some of the iterative aspects of the automated risk assessment application 127.

In the example shown in FIG. 6, the method 600 begins in box 603 following the completion of an initial search executed by the automated risk assessment application 127 in box 503 of the method 500, identification of initial data in box 506 of the method 500, and determination of at least one of the risk scores in boxes 509, 512, or 515 as described above with reference to FIG. 5. In box 603 of the method 600, following some subsequent search performed by the automated risk assessment application 127 in the same or similar manner as the search executed in box 503 of the method 500, the automated risk assessment application 127 can determine whether any new or additional data was discovered or obtained from executing such a subsequent search. For instance, the automated risk assessment application 127 can determine whether any new data indicative of a previously identified potential continuation event and/or a newly identified potential continuation event associated with the organization and/or the employee was discovered or obtained. In one example, the automated risk assessment application 127 can determine whether at least one of new governmental or industry data have been released to the public. If no new or additional data is identified in box 603, the automated risk assessment application 127 can repeat the operations of box 503 and box 506 until new or additional data is identified. Once such data is identified, the method 600 proceeds to box 606.

In box 606, the automated risk assessment application 127 can determine whether any initial weights assigned to the initial data identified in box 506 of the method 500 should be updated based on any or all new or additional data discovered or obtained at some iteration of the above-described search process. In this example, the automated risk assessment application 127 can also determine whether any new weights should be assigned to any or all such new or additional data.

If the automated risk assessment application 127 determines at box 606 that no existing weights need to be updated and/or no new weights need to be assigned, the method 600 proceeds to box 609. In box 609, the automated risk assessment application 127 can use any or all new or additional data identified at box 603 (e.g., data indicative of a new payment made by an employee toward existing continuation event coverage) to recalculate any or all risk scores previously calculated in boxes 509, 512, or 515 of the method 500.

If the automated risk assessment application 127 determines at box 606 that one or more existing weights need to be updated and/or one or more new weights need to be assigned, the method 600 proceeds to box 612. By updating existing weights or adding new weights to data terms of the machine learning models 130, the automated risk assessment application 127 can thereby update such models based on any or all of such new or additional data. In box 612, the automated risk assessment application 127 can use any or all new or additional data identified at box 603 (e.g., data indicative of a new payment made by an employee toward new existing continuation event coverage) to recalculate any or all risk scores previously calculated in boxes 509, 512, or 515 of the method 500 using the updated versions of the machine learning models 130.

The flowcharts of FIGS. 2, 5, and 6 respectively show the functionality and operation of an implementation of portions of the automated risk assessment application 127. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor 303 in a computer system or other system. The machine code may be converted from the source code, etc. If embodied in hardware, each block may represent a circuit or a number of interconnected circuits to implement the specified logical function(s).

Although the flowchart of FIGS. 2, 5, and 6 respectively show a specific order of execution, it is understood that the order of execution may differ from that which is depicted. For example, the order of execution of two or more blocks may be scrambled relative to the order shown. Also, two or more blocks shown in succession in any or all of the FIGS. 2, 5, or 6 may be executed concurrently or with partial concurrence. Further, in some embodiments, one or more of the blocks shown in any or all of the FIGS. 2, 5, or 6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the automated risk assessment application 127, the machine learning models 130, the coverage management application 133, the client application 148, the communications stack 312, and the second client application 448 that includes software or code can be embodied in any non-transitory computer-readable medium for use by or in connection with an instruction execution system such as, for example, a processor 303 in a computer system or other system. In this sense, the logic may include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can be embodied as or include any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random-access memory (RAM) including, for example, static random-access memory (SRAM) and dynamic random-access memory (DRAM), or magnetic random-access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the automated risk assessment application 127, the machine learning models 130, the coverage management application 133, the client application 148, the communications stack 312, and the second client application 448, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 300, or in multiple computing devices 300, in the same computing environment 103.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. As referenced herein in the context of quantity, the terms “a” or “an” are intended to mean “at least one” and are not intended to imply “one and only one.”

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A computing device, comprising:
a memory device to store computer-readable instructions thereon; and
at least one processing device configured through execution of the computer-readable instructions to:
execute a search of at least one digital platform having data associated with an employee of an organization via a computer network;
identify data indicative of a potential continuation event associated with at least one of the organization or the employee; and
determine, using a machine learning model and based at least in part on the data, a risk score for the potential continuation event occurring within a time frame.

2. The computing device of claim 1, wherein, to determine the risk score for the potential continuation event occurring within the time frame, the at least one processing device is further configured to:
weight, using the machine learning model, the data based on at least one of type, content, source trustworthiness, age, or relevance to the potential continuation event.

3. The computing device of claim 1, wherein the at least one processing device is further configured to:
execute iterative searches via the at least one digital platform to identify additional data indicative of at least one of the potential continuation event or a second potential continuation event associated with at least one of the organization or the employee.

4. The computing device of claim 3, wherein the at least one processing device is further configured to:
determine, using the machine learning model and based at least in part on the additional data, an updated risk score for the potential continuation event occurring within at least one of the time frame or an updated time frame.

5. The computing device of claim 3, wherein the at least one processing device is further configured to:
determine, using the machine learning model and based at least in part on the additional data, a risk score for the second potential continuation event occurring within a second time frame.

6. The computing device of claim 1, wherein the at least one processing device is further configured to:
determine a risk score for continuation event coverage being necessary in connection with existing continuation event coverage for the employee based at least in part on ownership interest of the employee in the existing continuation event coverage.

7. The computing device of claim 6, wherein the ownership interest is directly proportional to the risk score for continuation event coverage being necessary.

8. The computing device of claim 1, wherein the at least one processing device is further configured to:
cause one or more second computing devices to respectively perform at least one operation associated with at least one of the organization or the employee based on the risk score for the potential continuation event occurring within the time frame, the one or more second computing devices being independently associated with one or more second organizations.

9. The computing device of claim 1, wherein the at least one processing device is further configured to perform at least one of:
a conversion of the risk score for the potential continuation event to a corresponding risk score of a risk assessment system of a second organization; or
a conversion of a digital format of the risk score for the potential continuation event to another digital format utilized by the risk assessment system of the second organization.

10. The computing device of claim 1, wherein the data indicative of the potential continuation event comprises at least one of employment history data of the employee, economic news data indicating one or more economic trends associated with the organization, news data indicating one or more employee downsizing events by the organization, state unemployment insurance data associated with the organization, or resume data of the employee.

11. The computing device of claim 1, wherein the at least one processing device is further configured to:
determine a risk score for continuation event coverage being necessary for a length of time based at least in part on one or more employment gaps in which the employee previously elected to implement continuation event coverage.

12. An automated method for continuation event assessment, comprising:
executing, by at least one computing device, a search of a social media platform via a computer network to identify a plurality of employees of an organization;
identifying, by the at least one computing device, respective employment histories for individual ones of the plurality of employees; and
determining, by the at least one computing device using a machine learning model and based at least in part on the respective employment histories, a risk score for one or more continuation events occurring for the organization within a time frame.

13. The method of claim 12, further comprising:
determining, by the at least one computing device, a risk score for continuation event coverage being necessary for a length of time based at least in part on one or more gaps between employment for the plurality of employees in the respective employment histories.

14. The method of claim 12, wherein the risk score for the one or more continuation events is determined further based at least in part on a likelihood of the plurality of employees remaining with the organization during the time frame, the likelihood being based at least in part on an average employment duration.

15. The method of claim 12, wherein the risk score for the one or more continuation events is determined further based at least in part on economic news data indicating one or more economic trends associated with the organization.

16. The method of claim 12, wherein the risk score for the one or more continuation events is determined further based at least in part on news data indicating one or more employee downsizing events by the organization.

17. The method of claim 12, wherein the risk score for the one or more continuation events is determined further based at least in part on state unemployment insurance data associated with at least one of the organization or an industry associated with the organization.

18. The method of claim 12, wherein identifying the respective employment histories for the individual ones of the plurality of employees further comprises obtaining, by the at least one computing device, the respective employment histories via the social media platform.

19. The method of claim 12, wherein identifying the respective employment histories for the individual ones of the plurality of employees further comprises obtaining, by the at least one computing device, the respective employment histories from a plurality of resumes submitted to a resume data source.

20. An automated method for continuation event assessment, comprising:
executing, by at least one computing device, a search of at least one digital platform having data associated with an employee of an organization via a computer network;
identifying, by the at least one computing device, data indicative of a potential continuation event associated with at least one of the organization or the employee; and
determining, by the at least one computing device using a machine learning model and based at least in part on the data, a risk score for the potential continuation event occurring within a time frame.
